(19) United States
(12) Patent Application Publication
(10) Pub. No.: US 2016/0369122 A1
(43) Pub. Date: Dec. 22, 2016

(54) GRADIENT POLYMER COMPOSITIONS FOR ELASTOMERIC WALL AND ROOF COATINGS

(71) Applicant: ROHM AND HAAS COMPANY, Philadelphia, PA (US)

(72) Inventors: Joseph M. Rokowski, Barto, PA (US); Ann E. Evans, Coatesville, PA (US)

(21) Appl. No.: 15/122,287

(22) PCT Filed: Feb. 25, 2015
(86) PCT No.: PCT/US15/17421

§ 371 Date: Aug. 29, 2016

Related U.S. Application Data
(60) Provisional application No. 61/946,246, filed on Feb. 28, 2014.

(51) Int. Cl. C09D 133/12; C09D 7/00; C09D 7/12; C09D 5/00

(52) U.S. Cl. CPC C09D 133/12; C09D 5/00; C09D 7/007; C09D 7/1283; C09D 7/1216

(57) ABSTRACT

The present invention provides aqueous compositions for use as elastomeric roof coatings having excellent tint retention which comprise (i) one or more gradient emulsion copolymers having a weight average particle size of from 20 to 550 nm, (ii) a large particle size filler, preferably silica, (iii) one or more chromatic colorants other than a white colorant in the amount of from 0.2 to 15 wt. %, based on the total weight of solids in the composition, and (iv) other pigments, extenders or fillers, wherein the resulting composition has a particle volume concentration (% PVC) of from 20 to 65%. The present invention provides methods of making the one or more gradient emulsion copolymers.

The present invention relates to coating compositions for low volatile organic content (VOC) elastomeric roof and wall coatings with excellent tint retention comprising power feed or gradient emulsion copolymers having a broad measured glass transition temperature (measured Tg) which are the copolymerization product of a soft monomer composition which when polymerized would provide a polymer having a calculated Tg of below −5° C. and hard comonomer composition which when polymerized would provide a polymer having a calculated Tg of from 20° C. to 150° C., the gradient emulsion copolymer further having a weight average particle size of from 200 to 550 nm, preferably, from 225 to 350 nm, one or more large particle size filler chosen from a pigment, an extender and mixtures thereof, preferably silica, and from one or more chromatic colorant other than a white colorant, as well as to methods of making the gradient emulsion copolymer. More particularly, it relates to deep tint aqueous compositions comprising the gradient emulsion copolymer, the large particle size filler and the chromatic colorant, the compositions having a pigment volume concentration (% PVC) of from 20 to 65% or, preferably, from 25 to 55% to coated roofing substrates made from such aqueous coating compositions and to methods of making the aqueous compositions.

Elastomeric roof coatings have recently become popular as an inexpensive low VOC solution for extending the life of many kinds of roofs, including roofs from organic materials, such as built up roofs, modified bitumen roofs and membranes, sprayed polyurethane foam roofs, thermoplastic polyolefin membranes, ethylene propylene diene rubber (EPDM) roofs, as well as aluminum and metal roofs and even tile roofs. White elastomeric roof coatings have been useful in reducing energy costs as they reflect heat off of roofs, especially in urban areas where the roofs before coating are often black or dark in color.

In North America, the white elastomeric roof coating compositions have been made to meet rigorous coating performance standards for tensile strength, elongation, dirt pickup resistance (DPUR), low temperature flexibility, water resistance and adhesion to substrates. These elastomeric roof coating performance standards can be achieved from coating compositions comprising separate polymers, one of which comprises a hard composition, and the other of which comprises a soft composition. For example, long term DPUR and surface film toughness are generally derived from polymers with relatively high Tgs (i.e. >−15° C.) whereas film formation and low temperature flexibility (LT flex) are found in compositions comprising emulsion polymers having low Tgs (i.e. <−15° C.). All of these properties are not achievable in one emulsion polymer, and so the properties of film formation/LT flex and DPUR/film toughness are considered contradictive properties: One gives up toughness and DPUR in exchange for film formation and low temperature flexibility.

Outside North America, markets outside the US have a preference for better DPUR and higher tensile strength which are defined by higher Tg polymers. Markets in these regions do not need to meet the LT flex performance required in North America. However, the markets in these regions satisfy demand for deep tint and vivid colors which tend to fade or bleach over time. No known emulsion copolymers have sufficient DPUR, tensile strength, elongation and tint retention for use in elastomeric roof coating compositions that meet the market accepted standards for roof coatings outside North America. Further, no emulsion copolymer composition or blend has been found which meets the tint retention needs of these markets.

Japan patent publication JP 2000-319301A, to Showa Highpolymer Co., Ltd. discloses power feed or gradient acrylic emulsion copolymers having a Tg of −35° C. to −15° C., wherein the polymers are made by a power feed process comprising feeding a monomer emulsion from a feed vessel into a reaction vessel, and after a delay or holdback period, feeding a hard monomer mixture into the feed vessel which continuing to feed the contents of the feed vessel into the reaction vessel. The gradient or power feed emulsion copolymers in JP 2000-319301A have too small a particle size (150 nm) to make them useful for elastomeric roof coatings. Further, JP 2000-319301A fails to disclose, inherently or literally, any deeptone, medium tone, pastel or dark colored coating compositions and fails to provide any way to make a roof coating having suitable tint retention.

The present inventors have sought to solve the problem of providing effective waterborne elastomeric roof coating compositions that provide excellent tint retention in a deeptone or dark colored coating formulation as well as acceptable contradictive properties of, on one hand, film formation and LT flex, and, on the other hand, DPUR.

### STATEMENT OF THE INVENTION

1. In accordance with the present invention, low volatile organic content (VOC) aqueous compositions for elastomeric roof and wall coatings comprise (i) one or more gradient emulsion copolymers having a broad measured glass transition temperature (measured Tg) which one or more gradient emulsion copolymers are the copolymerization product of (a) a soft vinyl or acrylic monomer composition of one or more nonionic vinyl or acrylic monomer and at least one ethylenically unsaturated acid functional monomer, such as an ethylenically unsaturated carboxylic acid, preferably, acrylic, methacrylic acid, itaconic acid, or a salt thereof, which soft vinyl or acrylic monomer composition when polymerized would provide a polymer having a calculated Tg of from −100 to −5° C., or, preferably, from −80 to −10° C., and (b) from 20 to 50 wt. %, or, preferably, from 23 to 45 wt. %, based on the total weight of monomers used to make the gradient emulsion copolymer, of a hard monomer composition which when polymerized would provide a polymer having a calculated Tg of from 20° C. to 150° C., or, preferably, from 50 to 130° C., the one or more gradient emulsion copolymers further having a weight average particle size of from 200 to 550 nm, preferably, from 225 to 350 nm, or, more preferably 250 nm or higher; (ii) one or more large particle size filler chosen from a pigment, an extender and mixtures thereof, preferably silica or nepheline syenite (sodium potassium aluminum silicate), and (iii) one or more chromatic colorants other than a white colorant in the amount of from 0.2 to 15 wt. %, based on the total weight of solids in the composition, or, preferably, from 0.5 to 10 wt. %, wherein the aqueous composition has a pigment volume concentration (% PVC) of from 20 to 65% or, preferably, from 25 to 55%.

2. The composition of 1, above, wherein the (i) one or more gradient emulsion copolymers comprise the copolymerization product of (a) the least one ethylenically unsaturated acid functional monomer or its salt in the amount of from 0.2 to 5 wt. %, or, preferably, from 0.3 to 2.5 wt. %, based on the total weight of monomers used to make the gradient emulsion copolymer.

3. The composition of 1 or 2, above, wherein the (i) one or more gradient emulsion copolymers comprises the copolymerization product of (a) the soft vinyl or acrylic monomer composition with (b) methyl methacrylate as the hard monomer composition.

4. The composition of 1, 2 or 3, above, wherein the amount of the (ii) one or more large particle size filler ranges from 20 to 50 wt. %, or, preferably, from 25 to 40 wt. %, based on the total weight of solids in the composition.

5. The composition of 1, 2, 3, or 4, above, wherein the amount of the (ii) one or more large particle size filler has an weight average particle size of from 1 to 15 μm or, preferably, from 1.5 to 12 μm.

6. The composition of 1, 2, 3, 4, or 5, above, which is substantially zinc free or has a zinc oxide in the amount of up to 10 wt. %, based on total composition solids, that has a weight average particle size of from 0.5 to 4 μm.

7. In another aspect of the present invention, methods of making a gradient emulsion copolymer comprise a) providing a polymerization vessel containing a mixture of one or more initiator, one or more acrylic emulsion seed polymer and water, b) gradually feeding from a soft monomer vessel into the polymerization vessel a soft monomer composition of a vinyl or acrylic monomer or monomer mixture which would when polymerized provide a polymer having a calculated Tg from −100 to −5° C., or, preferably, from −80 to −10° C., and aqueous emulsion polymerizing the soft vinyl or acrylic monomer or monomer mixture in the polymerization vessel and b) after feeding from 20 to 65 wt. % of the total vinyl or acrylic monomer composition into the polymerization vessel, gradually feeding a hard monomer composition into the soft monomer vessel at a rate R2, which hard monomer composition would when polymerized would provide a polymer having a calculated Tg of from 50° C. to 150° C., or, preferably, from 75 to 130° C., while continuing to gradually feed all monomers remaining in the soft monomer vessel into the polymerization vessel and polymerizing all monomer compositions to form an aqueous gradient emulsion copolymer having a weight average particle size of from 200 to 550 nm, preferably, from 225 to 350 nm, or, more preferably 250 nm or higher.

8. The methods of 7, above, wherein the soft monomer composition comprises at least one ethylenically unsaturated acid functional monomer or its salt in the amount of from 0.2 to 5 wt. %, or, preferably, from 0.3 to 2.5 wt. %, based on the total weight of monomers used to make the gradient emulsion copolymer.

9. The methods of any of 7 or 8, above, wherein the acrylic emulsion seed polymer is formed in situ by polymerizing it in the polymerization vessel prior to providing the polymerization vessel with the mixture of one or more initiator, one or more acrylic emulsion seed polymer and water.

10. The methods of 7, 8, or 9, above, wherein the hard monomer composition comprises methyl methacrylate.

11. The methods of 7, 8, 9, or 10, above, wherein the amount of the hard monomer composition ranges from 20 to 50 wt. %, or, preferably, from 23 to 45 wt. %, based on the total weight of monomers used to make the gradient emulsion copolymer.

12. The methods of 7, 8, 9, 10, or 11, above, wherein the rate R2 of gradually feeding the hard monomer composition into the soft monomer vessel is selected so that all of the hard monomer composition is fed into the soft monomer vessel at the same time or before all monomers remaining in the soft monomer composition has been fed into the polymerization vessel.

13. In yet another aspect of the present invention, methods of making the aqueous low VOC compositions of any of 1 to 6, above, comprise combining (i) the one or more gradient emulsion copolymers with (ii) one or more large particle size filler, preferably silica or nephiline syenite (sodium potassium aluminum silicate), (iii) one or more chromatic colorant other than a white colorant in the amount of from 0.2 to 15 wt. %, based on the total weight of solids in the composition, or, preferably, from 0.5 to 10 wt. %, and (iv) other pigments, extenders or fillers, wherein the resulting composition has a pigment volume concentration (% PVC) of from 20 to 65% or, preferably, from 25 to 55%.

14. In still yet another aspect of the present invention, methods of using the aqueous low VOC compositions of 13, above, comprise applying the compositions to a roofing substrate and letting it dry.

15. In still yet even another aspect of the present invention, coated roofing substrates comprise a roofing substrate made by the method of 13, above.

Unless otherwise indicated, all temperature and pressure units are room temperature and standard pressure (1 atmosphere).

All phrases comprising parentheses denote either or both of the included parenthetical matter and its absence. For example, the phrase “(meth)acrylate” includes, in the alternative, acrylate and methacrylate.

As used herein, the term “ASTM” refers to publications of ASTM International, West Conshohocken, Pa.

As used herein, the term “chromatic colorant” refers to any chromatic colorant or pigment that provides opacity to and the primary coloration of a paint whether white or another color shade. Titanium dioxide is a white chromatic colorant.

As used herein, the term “(meth)acrylate” means acrylate, methacrylate, and mixtures thereof and the term “(meth)acrylic” used herein means acrylic, methacrylic, and mixtures thereof.

As used herein, the term “pigment volume concentration” or % PVC refers to the quantity calculated by the following formula:

$$PVC ( \% ) = \frac{( \begin{matrix}volume of pigment ( s ) + \\ volume of extender ( s ) + volume of filler ( s )\end{matrix}}{Total dry volume of coating} \times 100$$

As used herein, the term “polymer” refers, in the alternative, to a polymer made from one or more different monomer, such as a copolymer, a terpolymer, a tetrapolymer, a pentapolymer etc., and may be any of a random, block, graft, sequential or gradient polymer.

As used herein, the term “solids” means for an aqueous composition all parts of the aqueous compositions of the present invention except for water and volatiles or VOCs that would evaporate under conditions of ambient temperature and pressure (the “use conditions”).

As used herein, the term “polymer solids” refers to the polymerized monomers, chain transfer agents and non-volatile surfactants in any emulsion (co)polymer.

As used herein, the term “measured glass transition temperature” or “measured Tg” refers to the glass transition temperature of a material as determined by Differential Scanning calorimetry (DSC) scanning from −90° C. to 150° C. at a rate of 20° C./min on a DSCQ2000 manufactured by TA Instrument, New Castle, Del.

The Tg is the inflection point of the curve of heat flow vs. temperature or the maximum value on the plot of its derivative.

As used herein, the term “broad measured glass transition temperature (broad measured Tg)” refers to a DSC glass transition wherein either the onset or final temperature of the recorded temperature curve are poorly defined such that no meaningful single measured Tg can be taken, and instead only a range of measured Tgs can be recorded. An example of a polymer having a broad measured Tg is a powerfeed emulsion copolymer.

As used herein, unless otherwise indicated, the term “calculated Tg” or “calculated glass transition temperature” refers to the Tg of a theoretical polymer having a weight average molecular weight of 50,000 calculated by using the Fox equation (T. G. Fox, Bull. Am. Physics Soc., Volume 1, Issue No. 3, page 123 (1956)). For example, to calculate a Tg of a copolymer of a monomer mixture of monomers M1 and M2, 1/Tg=w(M1)/Tg(M1)+w(M2)/Tg(M2), wherein w(M1) is the weight fraction of monomer M1 in the copolymer, w(M2) is the weight fraction of monomer M2 in the copolymer, Tg(M1) is a published glass transition temperature (“Fox Tg”) of a high molecular weight homopolymer (>50 k weight average MW) of M1, Tg(M2) is a published glass transition temperature of a high molecular weight homopolymer of M2, and all temperatures are in ° K. Suitable published glass transition temperatures are available at, for example, http://www.sigmaaldrich.com/img/assets/3900/Thermal_Transitions_of_Homopolymers.pdf. For example, the calculated Tg or glass transition temperature of a soft monomer alone is the glass transition temperature of a homopolymer of that soft monomer having a weight average MW of 50,000 or more; and the calculated Tg or glass transition temperature of a soft monomer mixture is the glass transition temperature of a copolymer of that soft monomer mixture having a weight average MW of 50,000 or more as given by the Fox equation.

As used herein, the term “substantially zinc free” refers to a composition containing less than 750 ppm of zinc, whether in elemental form, i.e. as a metal, as an ion or as that portion of a compound that is itself zinc, such as the zinc in zinc oxide, or a salt.

As used herein, unless otherwise specified, the term “weight average particle size” for any pigment, extender or filler refers to a particle size measured by light scattering using a BI-90 particle size analyzer (Brookhaven Instruments Corp. Holtsville, N.Y.) and taking the weight average of the particle size distribution.

As used herein, the term “weight average molecular weight” or “MW” refers to the weight average molecular weight of a polymer as measured by aqueous gel permeation chromatography (GPC) against a polyacrylic acid (PAA) standard of a copolymer that is hydrolyzed in KOH.

As used herein, the phrase “wt. %” stands for weight percent.

The present inventors have found that coating compositions that comprise one or more elastomeric gradient emulsion copolymers made by power feed emulsion polymerization offer improvements in DPUR and tint retention which is important for markets in the Middle East, the Near East, Southeast Asia, Africa and South and Central America. During a power feed process, the composition of the monomer emulsion is continuously changing resulting in a gradient polymer composition with corresponding gradient Tgs throughout each individual particle. Specifically, elastomeric roof coating (ERC) polymers made by a gradient process with a hard monomer holdback and, preferably, a soft monomer feed finish, exhibit improved dirt pickup resistance (DPUR), water resistance, tensile strength and, if they include a chromatic colorant (i.e. a color pigment other than white) a tint retention not achievable with conventional ERC polymers. The approach can be applied to Elastomeric Wall Coatings (WC) and Elastomeric Roof Coatings (ERC) to achieve a desirable balance of flexibility together with improved tint retention which current ERC products do not have. Coatings having seemingly contradictive properties of film formation/Low T flex and DPUR/film toughness can be attained in this manner.

The gradient emulsion copolymers of the present invention comprise the emulsion copolymerization product of one or more soft vinyl or acrylic monomer, including at least one acid monomer and, one or more hard acrylic or vinyl monomer, with vinyl aromatic monomers optional or, optionally, absent. As is known in the art, the monomer mixture is selected to give a desired calculated Tg.

Preferably, to improve weatherability in coatings comprising them, the emulsion copolymer of the present invention comprises the copolymerization product of a monomer mixture that contains no styrene or vinyl aromatic monomer.

Suitable vinyl or acrylic monomers (a) for use in the soft monomer composition may include, for example, butyl acrylate, ethyl acrylate, methyl acrylate, ethylhexyl acrylate (EHA), octyl methacrylate, isooctyl methacrylate, decyl methacrylate (n-DMA), isodecyl methacrylate (IDMA), lauryl methacrylate (LMA), pentadecyl methacrylate, stearyl methacrylate (SMA), octyl acrylate, isooctyl acrylate, decyl acrylate, isodecyl acrylate, lauryl acrylate (LA), the (C₁₂ to C₁₈) alkyl methacrylates, cyclohexyl acrylate and cyclohexyl methacrylate.

Suitable hard vinyl or acrylic monomers (b) for use in the hard monomer composition may include, for example, methacrylic ester monomers including C₁ to C₆ alkyl methacrylates, such as methyl methacrylate (MMA), ethyl methacrylate; (meth)acrylonitrile and (meth)acrylamide; vinyl esters, such as vinyl acetate and vinyl versatate; and vinyl aromatic monomers, such as styrene.

To improve stability in aqueous systems, the gradient emulsion copolymers of the present invention include acid functionality. Suitable ethylenically unsaturated acid functional monomers are included in the feed of the soft monomer composition and may include addition polymerizable carboxylic acids, salts thereof, anhydrides thereof, and phosphorous containing or sulfur containing acid functional monomers. Examples of suitable acid monomers may include, for example, maleic acid or anhydride, phosphoalkyl (meth)acrylate, meth)acrylamidopropane sulfonate and, preferably, methacrylic acid (MAA), acrylic acid (AA) and itaconic acid.

Preferably, to prevent weatherability or outdoor durability problems, the amount of vinyl aromatic monomers should range 19.5 wt. % or less or, preferably, 10 wt. % or less, or, more preferably, 5 wt. % or less, based on the total weight of monomers used to make each of the gradient emulsion copolymers.

Preferably, to increase the mechanical properties made from the aqueous compositions of the present invention, the gradient emulsion copolymers comprise the copolymerized product of a (meth)acrylonitrile in the amount of 11 wt. % or less or, preferably, 8 wt. % or less, based on the total weight of monomers used to make each of the gradient emulsion copolymers.

Adhesion promoter monomers such as hydrolysable silane functional (meth)acrylates, such as (meth)acryloyloxypropyl trialkoxy silanes, and ureido (meth)acrylates may be included in the soft vinyl or acrylic monomer composition. Suitable amounts of such adhesion promoter monomers may range from 0 to 5 wt. %, based on the total weight of monomers used to make the gradient emulsion copolymers, or, preferably, 0.1 to 4 wt. %.

The gradient emulsion copolymers of the present invention are formed by a power feed process. In power feed polymerization, the soft monomer composition is gradually fed into a polymerization vessel over the total monomer feed time and, after a time period that begins with the start of the soft monomer composition feed and ends when the start of the hard monomer composition feed, the hard monomer composition is fed into the soft monomer composition while the soft monomer composition is continually fed into the polymerization vessel. In the methods of the present invention, the time period or delay from the beginning of the total monomer feed time (the time at which the soft monomer composition feed into the polymerization vessel is started) to the time at which the hard monomer composition is fed into the soft monomer composition is expressed as a percentage of the total monomer feed time. It is this time period that enables the provision of separate hard and soft phases in the aqueous emulsion copolymer of the present invention.

The methods of making the gradient emulsion copolymers of the present invention comprises starting the feed of the hard monomer composition into the soft monomer composition (and from there into the polymerization vessel) after feeding from 20 to 65 wt. %, or, preferably, 25 to 50 wt. %, of the total soft monomer composition into the polymerization vessel. This is referred to a hard monomer composition holdback or hard holdback.

Preferably, the feed rates of either or both the soft monomer composition and the hard monomer composition may held constant during polymerization. More preferably, such feed rates can be ramped starting at a slow feed rate for less than 50 wt. % of the total feed time of each soft or hard monomer composition, and then sped up for the remainder of the total feed time, for example, to double the slow feed rate.

Preferably, to improve elongation and the low temperature flexibility of coatings made from compositions of the gradient emulsion copolymers of the present invention, the total monomer feed time for the hard monomer composition ends simultaneously with the soft monomer composition or, more preferably, the hard monomer composition feed ends before the end of the feed time for the soft monomer composition, such as, for example, ending during the last 10 wt. % of, or, the last 5% of the feed time for the soft monomer composition.

The gradient emulsion copolymers of the present invention can be polymerized by emulsion polymerization techniques well known in the art for making emulsion copolymers from hydrophobic monomers, which are mostly but not all soft acrylic monomers (a) suitable for use in the present invention. For example, U.S. Pat. No. 5,521,266, to Lau, discloses suitable polymerization processes suitable for forming emulsion copolymers made from one or more hydrophobic monomer. The hydrophobic monomer can be complexed with a macromolecular organic compound having a hydrophobic cavity by mixing them to form a complexed mixture, and charging the complexed mixture, along with any other monomers to a reaction vessel. Alternatively, a macromolecular organic compound having a hydrophobic cavity may be added to the reaction vessel before, during or after the monomer mixture has been charged. Suitable macromolecular organic compounds having a hydrophobic cavity may include, for example, cyclodextrin and cyclodextrin derivatives; cyclic oligo saccharides having a hydrophobic cavity such as cycloinulohexose, cycloinuloheptose, and cycloinuloctose; calyxarenes; and cavitands. The ratio of soft acrylic monomer to the macromolecular organic compound having a hydrophobic cavity may range from 1:5 to 5000:1, preferably 1:1 to 1000:1.

The gradient emulsion copolymers of the present invention have a relatively large weight average particle size of from 200 to 550 nm, preferably, from 225 to 400 nm which improves adhesion problem caused by having too small an average particle size, reduces sedimentation, instability and coating tack that results when the polymers have too large an average particle size, and enables an increased critical % PVC of compositions containing them, i.e. the non-binder loading capacity of the coating compositions. Larger particle size gradient emulsion copolymers, above a 500 nm weight average particle size, may be made from polymer compositions stabilized by additives, thickeners and/or biocides etc.

Suitable emulsion polymerization methods for making such large particle size polymers are conventional in the art and include, for example, (i) polymerizing with small amounts of surfactant, such as, for example, from 0.01 to 0.4 wt. %, based on the total weight of monomers, preferably, 0.08 to 0.32 wt. %, (ii) polymerizing under low shear during polymerization, increasing the ion balance or salt concentration of the composition before, during or after polymerization and in use, (iii) polymerizing in the presence of an acrylic emulsion seed polymer, which can be preformed or formed in situ in the polymerization vessel, and combinations thereof. In addition, very large particle size polymers (up to 800 nm) may be made by known multi-modal and multi-lobal polymerization methods.

In addition, polymerization in the presence of an amount of surfactant below 0.4 wt. %, based on the total weight of monomers, may yield a larger average particle size and improve the water resistance of coatings or films made from the coating compositions of the present invention.

To improve blister resistance and adhesion, suitable emulsion copolymers have a weight average molecular weight of from 10,000 to 750,000, preferably, from 50,000 to 500,000. Such emulsion copolymers may be made by conventional methods, such as, for example, including in the polymerization a wide variety of chain transfer agents. These include, for example, alkyl mercaptans, halogen compounds, and other well-known agents.

A chain transfer agent such as, for example, n-dodecylmecaptan may be used in amounts ranging from 0.1 wt. %, based on the weight of total monomers used to make the emulsion copolymer, to 2.0 wt. %, or preferably, 0.2 to 1.0 wt. %, or, more preferably, 0.25 to 0.8 wt. %. Preferably, the chain transfer agent is hydrophobic, such as n-dodecyl mercaptan (n-DDM or DDM) or any C₄ to C₁₈ mercaptan.

In one example of a suitable power feed emulsion polymerization method, the monomers are subject to gradual addition emulsion polymerization with cyclodextrin and 0.01 to 0.4 wt. %, based on total monomer weight, of a nonionic and/or anionic surfactant.

The aqueous compositions of the present invention further include one or more chromatic colorants other than a white colorant in the amount of from 0.2 to 15 wt. %, based on the total weight of solids in the composition, or, preferably, from 0.5 to 10 wt. %. Suitable coating compositions within the scope of the present invention include compositions used as deep tone, pastel and medium tone, as well as dark colored. These can be any compositions having the requisite amount of one or more chromatic colorants.

The chromatic colorants of the present invention may have a refractive index of at least 1.35, for example, 1.7 and may act as opacifiers.

Suitable chromatic colorants can be in the form of finely ground powder suspensions in a liquid vehicle, water or oil-based. Examples of the chromatic colorants other than a white colorant may include, but are not limited to, carbon black, iron oxide and other known pigments; and organic colorants.

Suitable organic chromatic colorants may be any of mono and di-azo pigments such as toluidine red and quinacrodone red, phthalocyanines, ferrocyanates, molybdates, and carbon blacks.

Suitable inorganic chromatic colorants may be any of oxides, sulfates, silicates and molybdates of, iron, titanium, nickel, chromium, lead, calcium, magnesium, barium; and silicates of copper and manganese.

Titanium dioxide is considered a white chromatic colorant pigment and can be used with chromatic colorants to form the coating compositions of the present invention. Preferably, the weight average particle size of titanium dioxide ranges from 0.2 to 0.3 μm.

The aqueous compositions of the present invention further comprise one or more pigment(s), filler(s) and extender(s), including one or more large particle size filler(s) or extender(s).

Extenders or fillers do not hide as well as pigments or colorants, but have a significant impact on the overall characteristics and performance of a paint, including hiding, durability, scrubbability and retention of color.

Suitable large particle size fillers may be, for example, silica clay, mica, talc, alumina silicates, microspheric ceramic beads, zinc oxide and nepheline syenite. Preferably, silica and nepheline syenite are used as an extender or filler.

Suitable extenders or fillers other than large particle size fillers may be, for example, any of the extenders which are useful as the large particle size fillers excluding zinc oxide, which can cause chalking. Preferably, silica and nepheline syenite are used as an extender or filler.

Preferably, to keep them from reacting or dissolving in other parts of the aqueous compositions of the present invention and to prevent chalking in deep tint coatings containing them, the large particle size fillers of the present invention have average particle sizes of from 1 to 15 μm, or, more preferably, from 1.5 to 12 μm, or, even more preferably, from 2 to 12 μm.

Preferably, to prevent frosting and keep the extenders, pigments or fillers from migrating to and depositing on the top of a coating made with the compositions of the present invention, pigments, fillers and extenders are substantially free of calcium carbonate, and have only zinc oxide with a weight average particle size of from 0.5 to 4 μm in the amount of up to 10 wt. %, based on total composition solids.

Preferably, the aqueous compositions of the present invention comprise less than 2 wt. % of total solids or less, or, more preferably, 1 wt. % or less of CaCO₃.

To better enable effective let down of the emulsion polymer onto pigments, colorants and extenders or fillers, the compositions of the present invention preferably comprise one or more dispersant, e.g. a hydrophilic dispersant, such as a polyMAA or a polyacid salt, e.g. alkali(ne) metal salt, for example, polyMAA, its Na salt. Any dispersant that can stabilize pigments, extenders and/or fillers and wet out substrate surface in use may be used. Suitable dispersants include both hydrophobic and hydrophilic dispersants, and are, preferably, hydrophilic dispersants.

Preferably, to improve aqueous composition stability and reduce the water swelling of coatings made from the aqueous compositions of the present invention, such compositions include a hydrophilic dispersant.

Hydrophilic dispersants contain the polymerization product of less than 30 wt. %, preferably 20 wt. % or less of monomers other than hydrophilic monomers like alkyl (meth)acrylates, dienes or olefins, based on the total weight of monomers used to make the copolymer. More preferred hydrophilic dispersants have a weight average molecular weight of 5,000 or more, preferably 8,500 or more.

Hydrophobic dispersants include emulsion copolymer dispersants or block copolymer dispersants comprising more than 20 wt. %, based on the total weight of copolymerized monomers, of any block of polymer that would not form a water soluble homopolymer (≧50 g/L dissolves at room temp upon simple mixing) at the weight average molecular weight of the dispersant block in use. Thus, if a block of a monomer in a block copolymer has a weight average molecular weight of 1,000 in the dispersant, then to determine if the dispersant is hydrophobic, a homopolymer having a weight average molecular weight of 1,000 of the same monomer used to make the block in the dispersant would be evaluated to see if it is water soluble.

Suitable hydrophilic dispersants may include, for example, copolymer dispersants like Tamol™ 851 (Na poly(MAA)) or 1124 (poly(AAco-hydroxypropyl acrylate)) dispersants (Dow Chemical, Midland, Mich.), or Rhodoline™ 286N dispersants (Rhodia, Cranberry, N.J.), Disponil™ Fes-77, a fatty alcohol polyglycol ether sulfate available from (Cognis, Cincinnati, Ohio) polybasic acid salts, such as potassium tripolyphosphate (KTPP), polycarboxylic acid salts, copolymer acid salts, alkali soluble resin salts, phospho ethyl methacrylate (PEM) polymer and copolymer dispersants, mono or oligo-phosphorous or sulfur containing acid salts, which can be organic or inorganic, e.g. KTPP or sulfonates. To avoid excessive water sensitivity, and possible loss of adhesion, any dispersants should be used in amounts of 2 wt. % or less, based on the total polymer solids in the compositions.

The aqueous low VOC compositions of the present invention may additionally comprise one or more of additional pigments, extenders, fillers, thickeners, such as hydroxyethylcellulose (HEC) or modified versions thereof, UV absorbers, surfactants, coalescents, wetting agents, thickeners, rheology modifiers, drying retarders, plasticizers, biocides, mildewicides, defoamers, colorants, waxes, and silica.

To insure enhanced weatherability, the compositions of the present invention may preferably include one or more UV absorber or light stabilizer, such as benzophenone (BZP), or butylated hydroxytoluene (BHT) or hindered amines in the total amount of from 0 to 1 wt. %, based on the total solids of the composition, preferably, 0.05 wt. % or more or up to 0.5 wt. %.

Preferably, improved adhesion is observed in coatings made from compositions comprising one or more hydrolysable silanes or alkoxy silanes, which preferably have two or three hydrolysable groups. Suitable amounts of epoxysilane, aminosilane, vinyl alkoxysilane are the same. Combinations of the epoxysilanes and aminosilanes may be used.

Suitable aminosilanes may comprises an amino-alkyl functional group and is hydrolysable, having, for example, one or more alkoxy group or aryl(alkyl)oxy functional group. Preferably, the amino silane has two or more amino functional groups and two or, more preferably, three hydrolysable groups, i.e. tri-alkoxy.

Examples of suitable aminosilanes include Momentive™ Silquest™A-1120 (Momentive Performance Materials, Albany, N.Y.) or Dow-Corning Z-6020 (Dow Corning, Midland, Mich.), each of which are aminoethylaminopropyl trimethoxysilanes. Other suitable silanes include, for example, Dow Corning Z-6040, which is glycidoxypropy trimethoxysilane, and Silquest Wetlink™ 78, (Momentive Performance Materials, Albany, N.Y.), a glycidoxypropylmethyl diethoxysilane.

Silanes may be used in amounts ranging from 0.2 wt. % or more, or up to 2.0 wt. %, preferably, 0.5 wt. % or more, or, preferably 1.5 wt. % or less, or, more preferably, 0.7 wt. % or more, based on the total weight of emulsion copolymer solids.

The aqueous compositions of the present invention may be prepared by mixing the elastomeric binder with conventional components in high speed dispersion equipment such as a Cowles disperser, or a Sigma mill for caulks and sealants.

To formulate the aqueous compositions of the present invention with a silane, the silane can be added with stirring, such as overhead stirring, preferably before pigments, fillers or extenders are added.

The solids level of aqueous coating compositions of the present invention may range 40 wt. % or higher and up to 80 wt. %, preferably, 50 to 70 wt. %, based on the total weight of the compositions.

The aqueous compositions of the present invention have a pigment volume concentration (% PVC) of from 20 to 65% or, preferably, from 25 to 55%.

In another aspect, the present invention provides methods of using the aqueous compositions of the present invention comprising applying the coating compositions of the present invention to a substrate, followed by drying, e.g. at ambient temperature and humidity or at elevated temperature and ambient humidity. Drying can comprise, for example, ambient drying.

The pigmented compositions are suitable for making deep tint or colored roof coatings or colored roof maintenance coatings in colors other than white.

The compositions of the present invention can be used on any weatherable substrate, such as a roof or a wall, with suitable substrates being asphaltic coatings, roofing felts, synthetic polymer membranes; modified bitumen membranes; foamed polyurethane, such as, spray polyurethane foam; metals, such as aluminum; previously painted, primed, undercoated, worn, or weathered substrates, such as metal roofs, weathered thermoplastic polyolefin (TPO), weathered poly(vinyl chloride) (PVC), weathered silicone rubber and weathered EPDM rubber. Less preferred roofing substrates may include cementitious substrates and previously painted cementitious substrates.

The aqueous compositions are preferably used as topcoats or topcoat maintenance coatings, especially if formulated with UV absorbers or light stabilizers, or can be used as the basecoat or maintenance basecoats in two coat systems, e.g. with a topcoat or mastic.

### EXAMPLES

The following Examples illustrate the advantages of the present invention. Unless otherwise indicated, all conditions of temperature are room temperature (22-24° C.) and all units of pressure are 1 atmosphere.

Test Methods: The following test methods are used in the Examples.

Mechanical Properties: Tensile Max: Tested by ASTM D-2370 (December, 2010); requirement is 1.4 minimum MPascal and specimen is 75 mm long and 13 mm wide, tested at 23° C. with crosshead speed of 25 mm/min, gage length of 25 mm; Elongation at Break: Tested by ASTM D-2370 (December, 2010) specimen is 75 mm long and 13 mm wide, tested at 23° C. with crosshead speed of 25 mm/min, gage length of 25 mm. Elongation must be 100% minimum after 1000 hours of Weather-O-Meter™ accelerated weathering.

Weather-O-Meter™ exposure: Weather-O-Meter™ accelerated weathering method is ASTM D4798 (January, 2011) for the indicated time period; Cycle used was A, uninsulated black panel temperature is 63° C., daylight filter is used, total minimum radiant energy used is 1260 kJ/(m² nm) at 340 nm, 151.2 MJ/m² at 300 to 400 nm.

Tint retention: Tint retention refers to the ability of a coating to retain its original color on exposure to natural or artificial conditions. This was measured for coatings prepared in duplicate on 7.5 cm×18 cm (3×6 inch) aluminum panels using a 1016 μm (40 mil or 0.040 inch) block drawdown and dried for 2 weeks in a Constant Temperature and Humidity room (i.e. 23° C. or 73.4° F. and 50% Relative Humidity). After the coatings are applied and dried, a colorimeter is used to measure the L*a*b* values of the unweathered coatings on one panel. For each panel, three readings are taken and averaged. The other panel (accelerated weathered panel) is then exposed in an Atlas Weather-O-Meter™ (Atlas Materials Testing Solutions, Chicago, Ill.) for 3000 hrs and removed. The accelerated weathered panel is then measured for L*a*b* values. For each panel, three readings are taken and averaged. The values of the weathered and unweathered panels are entered into the Equation below to generate a ΔE value. ΔE values of 2 or more are visibly discernible. ΔE values of 4 or more are substantially different. An acceptable limit for tint retention in roof coatings is a Delta E under twelve (12) units after 3000 hours WOM which simulates approximately six years exterior exposure, preferably, under seven (7) units.

Equation: Using (L*₁, a*₁, b*₁) and (L*₂, a*₂, b*₂), two colors in L*a*b*:

ΔE*_{ab}=\sqrt{(L*₂−L*₁)²+(a*₂−a*₁)²+(b*₂−b*₂)²}

ΔE*_{ab}≅2.3 corresponds to a JND (just noticeable difference)

In the Examples that follow, the following chemical abbreviations are used: BA: Butyl acrylate; BZP: Benzophenone; MMA: Methyl methacrylate; AA: Acrylic acid; MAA: Methacrylic acid; EHA: Ethyl hexyl acrylate; IA: Itaconic acid; UMA: Ethylene ureido ethyl methacrylate; n-DDM: n-dodecyl mercaptan.

### Example 3

### Synthesis of Gradient Emulsion Copolymer by Powerfeed Emulsion Polymerization

Emulsion polymerization was conducted in a four neck 5 liter round bottom reaction flask equipped with a condenser, a mechanical stirrer, a thermocouple, a monomer feed line, an initiator feed line and a nitrogen inlet in the following manner:

A reactor mixture comprising 500 g of deionized water and 15 g of β-cyclodextrin was added to the flask and its contents were heated to 90° C. under nitrogen sweep with stirring. A solution containing 0.65 g sodium carbonate dissolved in 20 g of water was added to the heated reactor mixture followed by a solution containing 2.6 g of ammonium persulfate (APS) dissolved in 20 g of water, further followed by a solution containing 2.2 g ammonia (28% in water) in an additional 3.0 g water for dilution, still further followed by a solution containing 89.5 g of acrylic seed emulsion polymer (Tg=17.5 C, 1.5 wt % MAA, 45 wt. % solids, weight average particle size 100 nm) to form a reaction medium. In a separate soft monomer vessel, a soft monomer emulsion (ME) shown in Table 1, below was prepared by mixing the indicated ingredients, including surfactant and monomers, with a magnetic stirrer. In a separate hard monomer vessel, a solution consisting of 1.7 g of ammonium persulfate (APS) in 98 g of water was prepared.

With the reaction medium in the reaction flask at a temperature of 81 to 86° C., the ME was fed into the reaction flask over a total monomer feed time of 120 minutes together with a cofeed of the APS solution. The temperature of the reaction mixture was held at 83° C. during the polymerization. Both the soft ME feed and the APS cofeed were begun at half of the full rate, 8.3 g/min for the ME and 0.45 g/min for the cofeed over the first 20 minutes of the feed and then ramped to full rate of 16.7 g/min for the ME and 0.91 g/min for the cofeed, and there held constant for the remaining 100 minutes of the feed. After 40 minutes of soft monomer composition feed time, a hard comonomer was fed into the soft monomer vessel, with the feed rate of the hard comonomer composition adjusted to end at same time as the soft monomer composition feed (after 120 minutes of total feed time).

At the end of the feeds, the temperature of the reaction mixture was held at 83° C. for 10 minutes followed by cooling. The product emulsion copolymers had solids contents ranging from 54 wt. % to 56 wt. % and a weight average particle size (B190) of 270 nm.

### Example 2

### Synthesis of Gradient Emulsion Copolymer by Powerfeed Emulsion Polymerization

The process of making the gradient emulsion copolymer of Example 3 from the composition indicated in Table 1, below was repeated except that a portion (21.1% or 107.2 g) of the hard monomer was added to the soft monomer vessel and only 78.9% or 400 g of the hard monomer was added to the hard monomer vessel.

The product emulsion copolymers had solids contents ranging from 54 wt. % to 56 wt. % and a weight average particle size (BI90) of 302 nm.

### Example 5

### Synthesis of Gradient Emulsion Copolymer by Powerfeed Emulsion Polymerization

The process of making the gradient emulsion copolymer of Example 3 from the composition indicated in Table 1, below was repeated except that the soft monomer employed was 2-EHA.

The product emulsion copolymers had solids contents ranging from 54 wt. % to 56 wt. % and a weight average particle size (BI90) of 303 nm.

### Comparative Example 4C

### Synthesis of Comparative Emulsion Polymer

Emulsion polymerization was carried out in a four neck 5 liter round bottom reaction flask equipped with a condenser, a mechanical stirrer, a thermocouple, a monomer feed line, an initiator feed line and a nitrogen inlet. To form a reactor mixture, 500 g of deionized water and 15 g of β-cyclodextrin were added to the flask and its contents were heated to 90° C. under nitrogen sweep with stirring. To the reactor mixture, a solution containing 0.65 g sodium carbonate dissolved in 20 g of water was added followed by a solution containing 2.6 g of ammonium persulfate (APS) dissolved in 20 g of water, further followed by a solution containing 2.2 g ammonia (28% in water) in an additional 3.0 g water dilution, and still further followed by a solution containing 89.5 g of acrylic seed emulsion polymer (Tg=17.5 C, 1.5 wt % MAA, 45 wt. % solids, weight avg. particle size 100 nm) to form a reaction medium.

In a separate vessel, a monomer emulsion (ME) was prepared by mixing with a magnetic stirrer the indicated ingredients, as shown in Table 1 below, including surfactant and monomers. In another separate vessel, an APS solution consisting of 1.7 g of ammonium persulfate (APS) in 98 g of water was prepared.

With the reaction medium in the reaction flask at a temperature of 81 to 86° C., the ME was fed into the reaction flask over a total monomer feed time of 120 minutes together with a cofeed of the APS solution. The temperature of the reaction mixture was held at 83° C. during the polymerization. Both feeds were begun at half of the full rate over the first 20 minutes of the feed and then ramped to full rates for the remaining 100 minutes of the feed. At the end of the feeds, the temperature of the reaction mixture was held at 83° C. for 10 minutes followed by cooling.

The product emulsion copolymers had solids contents ranging from 54 wt. % to 56 wt. % and a weight average particle size (BI90) of 329 nm.

### Comparative Example 1C

### Comparative Emulsion Polymer

The emulsion copolymer of Comparative Example 1C comprises a single stage gradual addition copolymer of a monomer mixture of 85 BA/12.35 MMA/1.65 MAA/1 ethylene ureido ethyl methacrylate monomer, where the numbers represent wt. % of monomer in the monomer mixture, and having a 350 nm weight average particle size. The copolymer was formed in the presence of 2.6 wt. %, based on the weight of total polymer solids, of an acrylic seed emulsion polymer (calculated Tg of −17.5° C. and 1.5 wt. % copolymerized, weight average particle size 100 nm) and 0.3%, based on the total weight of the monomer mixture, of a postadded UV absorber.

### Comparative Example 6C

### Synthesis of Comparative Emulsion Polymer

The process of making the gradient emulsion copolymer of Comparative Example 4C from the composition indicated in Table 1, below was repeated except that the soft monomer employed was 2-EHA.

The product emulsion copolymers had solids contents ranging from 54 wt. % to 56 wt. % and a weight average particle size (BI90) of 329 nm.

The powerfeed mechanics in the synthesis in inventive Examples 2, 3 and 5, above, are depicted as 40/80/0 in Table 1, below, meaning that there were 40 minutes of soft monomer composition feed from the soft monomer vessel before the feed of the hard monomer composition (hard holdback) was begun into the soft monomer vessel, 80 minutes for the hard holdback to be fed to the ME and 0 minutes after the holdout completed until the end of feeds). So 40+80+0=120 minute feeds. Both used a ramp in which the ME and co-feed were run at half rates for the first 20 minutes and then full rates for the remaining 100 minutes. The holdout was fed at full rate from its get-go. Both had a backbone of 65.34 BA/33.81 MMA/0.84 MAA.

In 2686, most of the MMA or 26.67% of the total monomer charge constituted the holdout, leaving 7.15% MMA in the main ME. In 2688, all of the MMA was held out.

TABLE 1
Gradient ERCs Compositions

| | | | Overall | Power |
|---|---|---|---|---|
| | Soft Monomer | Hard | Composition | Feed |
| Example | Emulsion (ME) (g) | Holdback | (wt. %) | Mechanics |
| 1C | n/a | none | 85BA/ | n/a |
| | | | 12.35MMA/ | |
| | | | 1.65MAA/ | |
| | | | 1 UMA// | |
| | | | 0.3% BP | |
| 2 | 330.0 water; | 400 g | 65.34BA/ | 40/80/0 |
| | 5.6 Surf¹; | MMA | 33.81MMA/ | |
| | 980.2 BA; | | 0.84MAA | |
| | 107.2 MMA; | | | |
| | 12.6 MAA | | | |
| 3 | 330.0 water; | 507.2 g | 65.34BA/ | 40/80/0 |
| | 5.6 Surf¹; | MMA | 33.81MMA/ | |
| | 980.2 BA; | | 0.84MAA | |
| | 12.6 MAA | | | |
| 4C | 330.0 water; | none | 65.34 2-EHA/ | n/a |
| | 5.6 Surf¹; | | 33.81MMA/ | |
| | 980.2 BA; | | 0.84MAA | |
| | 507.2 MMA; | | | |
| | 12.6 MAA | | | |
| 5 | 330.0 water; | 507.2 g | 65.34 2-EHA/ | 40/80/0 |
| | 5.6 Surf¹; | MMA | 33.81MMA/ | |
| | 980.2 2-EHA; | | 0.84MAA | |
| | 12.6 MAA | | | |
| 6C | 330.0 water; | none | 65.35BA/ | n/a |
| | 5.6 Surf¹; | | 33.82MMA/ | |
| | 980.2 BA; | | 0.83MAA | |
| | 507.2 MMA; | | | |
| | 12.6 MAA | | | |

¹Surfactant: Sodium lauryl sulfate (SLS, Stepan Co., Northfield, IL).

All aqueous copolymer compositions prepared from the copolymers in Table 1, above, were formulated as shown in Table 2, below, as white coatings having a 40% PVC and 51% Volume solids, without zinc oxide. Thereafter, each composition was tinted with a blue chromatic colorant, Colortrend™ Phthalo™ Blue 808-7214 (phthalocyanine, from Evonik Corporation, Theodore, AL) in the amount of 5.4 g of chromatic colorant (5-10% colorant solids in a glycol dispersion of talc carrier) added to 148.8 g of each formulation.

All coating formulations for testing had the following properties: Total % PVC: 43.32%; Volume Solids: 50.82%; Weight Solids: 65.25%; Total Dispersant: 0.55 wt. %; Total Coalescent: 2.70 wt. %; VOC (water excl): 70 g/I.

The formulations from Table 2, below, were formulated with each emulsion copolymer of the indicated Example in Table 1, above, were tested for Tint Retention, as described above, and the results were reported in Table 3, below.

TABLE 2
Aqueous Formulations for use in Coatings

| | |
|---|---|
| Material Name | pbw |

Grind

| | |
|---|---|
| Water | 127.74 |
| Tamol ™^{,1} 851 Hydrophilic Dispersant | 4.81 |
| Potassium tripolyphosphate (KTPP) Dispersant | 1.40 |
| Nopco ™^{,4} NXZ Defoamer | 1.90 |
| Omyacarb ™^{,2} Calcium Carbonate Extender (avg. particle | 446.98 |
| size = 12 μm as reported by mfr.) | |
| Ti-Pure ™^{,3} R-960 (Titanium Dioxide, avg. particle size = 0.25 | 70.53 |
| μm as reported by mfr.) | |
| Kadox ™^{,6} 915 (ZnO Pigment, avg. particle size = 0.13 μm as | 0.00 |
| reported by mfr.) | |
| Total | 653.36 |

LetDown

| | |
|---|---|
| Water | 25.05 |
| Emulsion copolymer Binder, one from each Example in Table | 471.47 |
| 1, above | |
| Ammonia (28% aq.) (Base) | 1.00 |
| Nopco ™^{,4} NXZ Defoamer | 1.90 |

Premix

| | |
|---|---|
| Texanol ™^{, 5} Coalescent | 7.01 |
| Skane ™^{,1} M-8 Biocide | 2.10 |

Premix

| | |
|---|---|
| Propylene Glycol (Solvent) | 24.45 |
| Natrosol ™^{, 7} 250 MXR Thickener | 4.21 |
| Totals | 1190.55 |

¹The Dow Chemical Co., Midland MI;
²Omya Inc., Cincinnati, OH;
³DuPont, Wilmington, DE;
⁴Nopco Paper Technology, Leeds, Great Britain;
⁵ Eastman Chemicals, Kingsport, TN;
⁶Horsehead Corporation, Monaca, PA;
⁷ Ashland Chemical Co., Covington, KY.

TABLE 3
Gradient ERCs: Tint Retention

| | ΔE | ΔE | ΔE |
|---|---|---|---|
| Example | 1000 Hr | 2000 Hr | 3000 Hr |
| 1C | 11.72 | 21.72 | 28.97 |
| 2 | 5.09 | 7.00 | 9.21 |
| 3 | 4.26 | 6.51 | 8.95 |
| 4C | 4.65 | 8.70 | 16.69 |
| 5 | 3.36 | 6.20 | 12.0 |
| 6C | 30.78 | 31.71 | 32.00 |

As shown in Table 3, above, the coatings made from aqueous gradient emulsion copolymer compositions have much better tint retention than those made from polymers made conventional monomer feeds in Examples 10 and 6C. As shown in inventive Examples 2 and 3 when compared to inventive Example 5, soft monomer compositions comprising butyl acrylate perform better than do soft monomer compositions comprising ethyl hexyl acrylate. Comparative Example 4C comprises a gradient emulsion copolymer made without a hard monomer composition holdback.

TABLE 4
Mechanical Properties & Low Temp Flex

| | Tensile | | Tensile |
|---|---|---|---|
| | Max | Elongation | Break |
| | MPa (psi) | Break % | MPa (psi) |
| Example | Initial/WOM¹ | Initial/WOM¹ | Initial/WOM¹ |
| 4C | 0.64/1.68 | 3.73/2.48 | 0.45/1.40 |
| | (92/241) | (534/355) | (64/200) |
| 2 | 1.62/2.63 | 0.69/0.63 | 0.52/2.06 |
| | (232/377) | (99/90) | 0.52/(75/295) |
| 3 | 1.31/2.13 | 1.18/0.97 | 0.79/1.69 |
| | (187/304) | (169/138) | (113/241) |
| 5 | 1.10/2.31 | 1.48/0.97 | 0.62/1.90 |
| | (157/330) | (211/138) | (89/272) |

¹1000 hour Weather-O-Meter ™ accelerated weathering.

The coatings made from the inventive aqueous gradient emulsion copolymer compositions have much higher tensile strength (max) and tensile break than the control of Example 4C, which emulsion copolymer has the same monomer composition as that of the gradient emulsion copolymer of Example 5.

We claim:

1. A low volatile organic content (VOC) aqueous composition comprising:
(i) one or more gradient emulsion copolymers having a broad measured glass transition temperature (measured Tg) which one or more gradient emulsion copolymers are the copolymerization product of (a) a soft vinyl or acrylic monomer composition of one or more nonionic vinyl or acrylic monomer and at least one ethylenically unsaturated acid functional monomer, which when polymerized would provide a polymer having a calculated Tg of from −100 to −5° C., and (b) from 20 to 50 wt. %, based on the total weight of monomers used to make the gradient emulsion copolymer, of a hard monomer composition which when polymerized would provide a polymer having a calculated Tg of from 20° C. to 150° C., the one or more gradient emulsion copolymers further having a weight average particle size of from 200 to 550 nm;
(ii) one or more large particle size filler chosen from a pigment, an extender and mixtures thereof; and,
(iii) one or more chromatic colorant other than a white colorant in the amount of from 0.2 to 15 wt. %, based on the total weight of solids in the composition, wherein the aqueous composition has a pigment volume concentration (% PVC) of from 20 to 65%.

2. The aqueous composition as claimed in claim 1, wherein the (i) one or more gradient emulsion copolymers are the copolymerization product of (a) soft vinyl or acrylic monomer composition having as the at least one ethylenically unsaturated acid functional monomer a monomer chosen from acrylic acid, methacrylic acid, itaconic acid, or a salt thereof.

3. The aqueous composition as claimed in claim 1, wherein the (i) one or more gradient emulsion copolymers comprise the copolymerization product of (a) a soft vinyl or acrylic monomer composition which when polymerized would provide a polymer having a calculated Tg of from preferably, from −80 to −10° C.

4. The aqueous composition as claimed in claim 1, the (i) one or more gradient emulsion copolymers comprise the copolymerization product of a) the least one ethylenically unsaturated acid functional monomer or its salt in the amount of from 0.2 to 5 wt. %, based on the total weight of monomers used to make the gradient emulsion copolymer.

5. The aqueous composition as claimed in claim 1, wherein the (i) one or more gradient emulsion copolymers comprise the copolymerization product of (a) the soft vinyl or acrylic monomer composition with (b) methyl methacrylate as the hard monomer composition.

6. The aqueous composition as claimed in claim 1, wherein the amount of the (ii) one or more large particle size filler ranges from 20 to 50 wt. %, based on the total weight of solids in the composition.

7. The aqueous composition as claimed in claim 1, wherein the (ii) one or more large particle size filler has an weight average particle size of from 1 to 15 μm.

8. The aqueous composition as claimed in claim 1, which is substantially zinc free.

9. The aqueous composition as claimed in claim 1, wherein the (ii) one or more large particle size filler is silica or nepheline syenite.

10. A method of making an aqueous low VOC composition comprising:
combining (i) the one or more gradient emulsion copolymers as claimed in claim 1, with (ii) one or more large particle size filler, (iii) one or more chromatic colorant other than a white colorant in the amount of from 0.2 to 15 wt. %, based on the total weight of solids in the composition, and (iv) other pigments, extenders or fillers, wherein the resulting composition has a pigment volume concentration (% PVC) of from 20 to 65%.
